(19) United States
(12) Patent Application Publication
(10) Pub. No.: US 2005/0218128 A1
(43) Pub. Date: Oct. 6, 2005

(54) Laser processing apparatus with polygon mirror

(76) Inventor: You-Hie Han, Daejeon-si (KR)

Correspondence Address: SHERIDAN ROSS PC, 1560 BROADWAY, SUITE 1200, DENVER, CO, 80202, US

(21) Appl. No.: 10/886,122

(22) Filed: Jul. 6, 2004

(30) Foreign Application Priority Data
Mar. 31, 2004 (KR) 10-2004-0022270

(51) Int. Cl. B23K 26/06

(52) U.S. Cl. 219/121.74

(57) ABSTRACT

The disclosure is directed to a laser processing apparatus employing a polygon mirror, capable of processing an object efficiently. The apparatus is comprised of a laser generator for emitting a laser beam, a polygon mirror rotating at the axis and having a plurality of reflection planes which reflect the laser beam incident thereon from the laser generator, and a lens irradiating the laser beam on an object, e.g., a wafer, that is settled on a stage, after condensing the laser beam reflected from the polygon mirror. In applying the laser beam to the wafer in accordance with a rotation of the polygon mirror, the stage on which the wafer is settled moves to enhance a relative scanning speed of the laser beam, which enables an efficient cutout operation for the wafer. As it uses only the laser beam to cutout the wafer, there is no need to change any additional devices, which improves a processing speed and cutout efficiency. Further, it is available to control a cutout width and to prevent a recasting effect by which vapors generated from the wafer during the cutout process are deposited on cutout section of the wafer, resulting in accomplishing a wafer cutout process in highly fine and precise dimensions.

### TECHNICAL FIELD

The present invention relates to a laser processing apparatus with a polygon mirror capable of processing an object by reflecting a laser beam on the polygon mirror.

### BACKGROUND ART

Since apparatuses using a laser beam have more advantage for cutting silicon wafers than other mechanical apparatuses, various studies about them have been advanced. One of the most advanced apparatus for cutting a wafer is an apparatus using a laser beam guided by ejected water from a high-pressure water jet nozzle.

A wafer cutout apparatus employing the high-pressure water jet nozzle irradiates a laser beam on a wafer with ejecting water through a high-pressure jet nozzle. As the water jet nozzle is easily worn away due to the high pressure, the nozzle has to be changed periodically.

The periodic change of the high-pressure jet nozzle causes inconveniences in conducting the wafer cutout process. It also results in lower productivity and higher manufacturing cost.

Also, since it is difficult for a conventional wafer cutout apparatus to offer fine line width, there are problems in adopting the apparatus to high-precision process.

Meanwhile a wafer cutout process using only a laser beam brings about a recasting effect which means vapors evaporated by a laser beam are deposited on cutout sides of wafer. It interrupts a wafer cutout process.

### DISCLOSURE OF INVENTION

To solve the aforementioned problems, an object of the present invention is to provide a laser processing apparatus with a polygon mirror, capable of processing an object such as a wafer precisely by preventing a recasting effect without changing any additional devices.

In the embodiment of the invention, a laser processing apparatus with a polygon mirror is comprised of: a laser generator for emitting a laser beam; a polygon mirror constructed of a plurality of reflection planes that reflect the laser beam which is emitted from the laser generator, thereon while rotating on an axis; and a lens for condensing the laser beam which is reflected on the polygon mirror and irradiating the laser beam on the object.

### BRIEF DESCRIPTION OF THE DRAWINGS

FIGS. 1A through 1C are schematic diagrams illustrating conceptual features of a laser processing apparatus employing a polygon mirror in accordance with the present invention.

FIG. 2 is a schematic diagram illustrating a conceptual feature of the laser processing apparatus employing the polygon mirror in accordance with the present invention.

FIG. 3 is a diagram illustrating overlapping laser beams in accordance with the present invention.

FIG. 4 is a diagram illustrating an exemplary embodiment of the laser processing apparatus with the polygon mirror in accordance with the present invention.

FIG. 5 is a diagram illustrating another embodiment of the laser processing apparatus with the polygon mirror in accordance with the present invention.

FIG. 6 is a flow chart explaining a procedure of processing an object in accordance with the present invention.

FIG. 7 is a schematic diagram illustrating a configuration of wafer processing by the laser processing apparatus with the polygon mirror in accordance with the present invention.

### DETAILED DESCRIPTION OF THE INVENTION

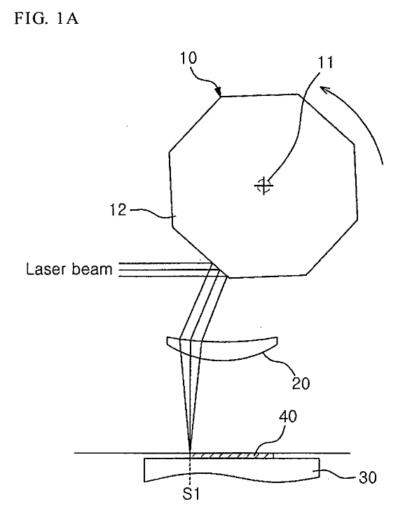

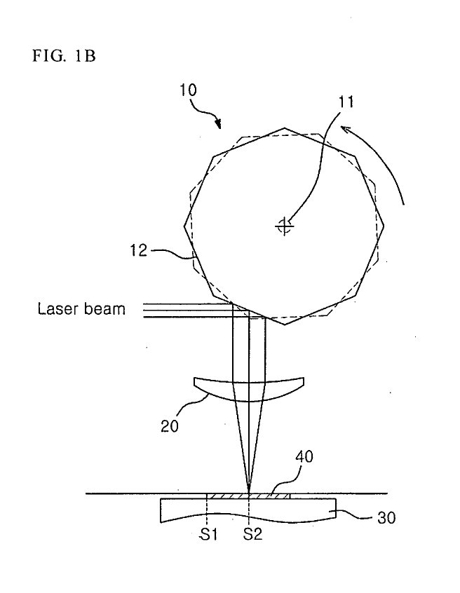

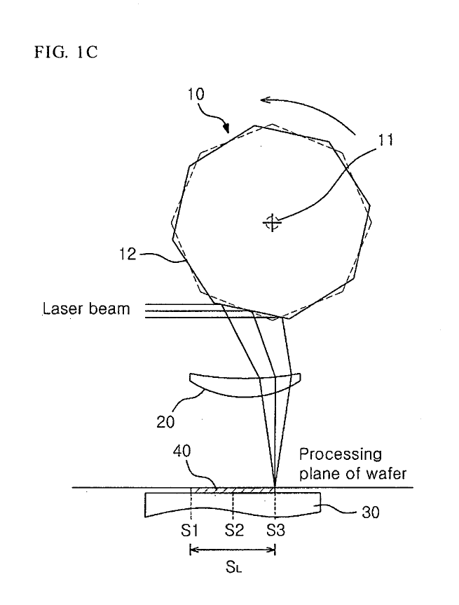

FIGS. 1A through 1C are schematic diagrams illustrating a conceptual feature of a laser processing apparatus employing a polygon mirror in accordance with the present invention.

As shown in FIGS. 1A through 1C, the laser processing apparatus is comprised of a polygon mirror 10 having a plurality of reflection planes and rotating at an axis 11, and a telecentric f-theta lens 20 condensing laser beams reflected from the reflection planes thereon. The lens 20 is installed in parallel with a stage 30 on which a wafer 40 to be cut out is settled, in order to condense laser beams reflected from the reflection planes thereon. Thus, a laser beam condensed on the lens 20 is irradiated to the wafer in perpendicular, which enables the wafer 40 (e.g., a semiconductor wafer) to be processed (able to be cut out) in a predetermined shape.

While the lens 20 may be composed of a couple groups of lenses, this embodiment uses a single lens in convenience on description.

FIGS. 1A through 1C illustrate the features that a laser beam reflected from the reflection plane 12 is applied to the wafer 40 being condensed through the lens 20 while the polygon mirror 10 is rotating in an anti-clockwise direction at the axis 11.

Referring to FIG. 1A, laser beams are reflected from the beginning part of the reflection plane 12 in accordance with the rotation of the polygon mirror 10, and then incident on a left end of the lens 20. The reflected laser beams are condensed on the lens 20 and irradiated to a predetermined position S1 of the wafer 40 in perpendicular.

Referring to FIG. 1B, when the polygon mirror 10 more advances its rotation to reflect the laser beams on a central part of the reflection plane 12, the reflected laser beams are incident on a central position of the lens 20 and condensed on the lens 20. The condensed laser beam on the lens 20 is irradiated on a predetermined position S2 of the wafer 40 in perpendicular.

Referring to FIG. 1C, when the polygon mirror 10 further advances its rotation, more than the case of FIG. 1B, to reflect the laser beams on a rear part of the reflection plane 12, the reflected laser beams on the rear part are incident on a right end of the lens 20 and condensed on the lens 20. The condensed laser beam on the lens 20 is irradiated on a predetermined position S3 of the wafer 40 in perpendicular.

As aforementioned throughout FIGS. 1A to 1C, the laser beams are applied to the predetermined positions S1 to S3 on the wafer 40 in accordance with the anti-clockwise rotation of the polygon mirror 10. The distance from S1 to S3 is regarded to as a scanning length S_{L} that means an interval to irradiate the wafer 40 by the reflection plane 12 along the rotation of the polygon mirror 10. A reflection angle of the laser beam, which is formed by the beginning and rear parts of the reflection plane 12 is referred to as a scanning angle θ.

Hereinafter, the theoretical feature of the present invention will be described in more detail.

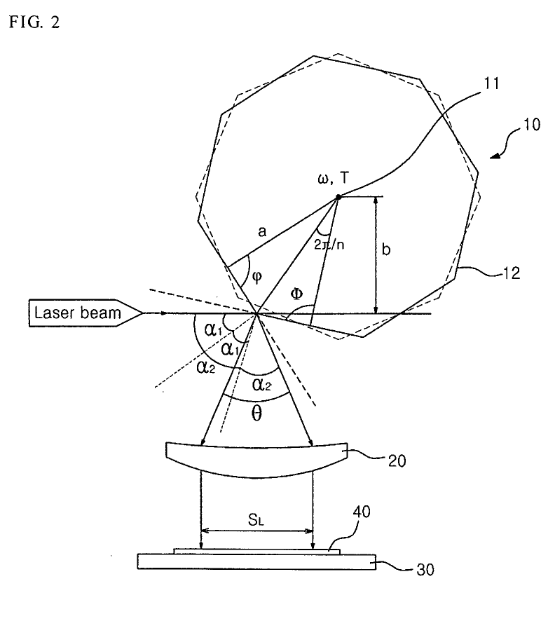

FIG. 2 illustrates a schematic configuration of the laser processing apparatus employing the polygon mirror in accordance with the present invention.

Referring to FIG. 2, the polygon mirror 10 constructed with n-numbered reflection planes rotates in a constant speed at the axis 11 in an angular velocity of ω and a cycle period T. A laser beam incident thereon is reflected from the reflection plane 12 and irradiated on the wafer 40 through the lens 20.

In the polygon mirror 10 having the n-numbered reflection planes 12, the scanning angle θ of the laser beam when one of the reflection planes 12 is rotating is summarized as the following Equation 1.

$$\begin{matrix}θ = 2 ( {α}_{2} - {α}_{1} ) \\ {α}_{1} = ϕ + ψ - \frac{π}{2} \\ {α}_{2} = ϕ + ψ - \frac{π}{2} + \frac{2 π}{n} \\ ∴ θ = \frac{4 π}{n}\end{matrix} \qquad [ Equation 1 ]$$

From the Equation 1, it can be seen that the scanning angle θ is twice the central angle

$$( \frac{2 π}{n} )$$

on the reflection plane 12 of the polygon mirror 10. Therefore, the scanning length S_{L}, that is a range of irradiation on the wafer 40 by the reflected laser beam applied from the reflection plane 12 of the polygon mirror 10, is determined by a morphological characteristic of the lens 20, as follows.

$$\begin{matrix}{S}_{L} = f \times θ = \frac{4 π f}{n} \\ {S}_{L} \text{:} Scanning length \\ f \text{:} Focal distance \\ θ \text{:} Scanning angle \end{matrix} \qquad [ Equation 2 ]$$

According to Equation 2, a laser beam reflected from each of the reflection planes 12 of the polygon mirror 10 while the polygon mirror 10 is rotating is irradiated on the wafer 40 by the length of S_{L}. In other words, the scanning length S_{L} of a laser beam irradiated on the wafer 40 in accordance with the rotation of the polygon mirror 10 is obtained from a product of the focal length ƒ and the scanning angle θ of the laser beam reflected from the reflection plane 12 of the polygon mirror 12.

By the way, as the polygon mirror 10 has the n-numbered reflection planes 12, an n-times scanning with the scanning length S_{L} is available in every one cycle of rotation of the polygon mirror 10. That is, a laser beam irradiated on the wafer 40 is applied to the wafer 40 by the scanning length S_{L}, overlapping in the wafer 40 by the number of the reflection planes 12 of the polygon mirror 10 when the polygon mirror 10 rotates one time. A scanning frequency during a unit time interval (e.g., one second) may be obtained from the following Equation 3.

$$\begin{matrix}\begin{matrix}Scanning frequency = \frac{ω n}{2 π} = \frac{n}{T} \\ ω \text{:} Angular velocity of the polygon mirror \\ T \text{:} Cycle period of the polygon mirror\end{matrix} & [ Equation 3 ]\end{matrix}$$

From Equation 3, in the condition with the n-numbered reflection planes 12 on the polygon mirror 10, it is possible to adjust the scanning frequency by controlling the cycle period or the angular velocity of the polygon mirror 10. In other words, the scanning length S_{L} is controllable in desired times of overlapping by varying the cycle period T or the angular velocity ω of the polygon mirror 10.

If the angular velocity ω of the polygon mirror 10 is constant, a relative wafer 40 scanning speed of the laser beam reflected from the polygon mirror 10 is enhanced by transferring the stage 30, on which the wafer 40 is settled, toward the direction reverse to the rotating direction of the polygon mirror 10. In other words, when the stage 30 is transferred to the direction reverse to the rotating direction of the polygon mirror 10, a wafer 40 scanning speed of the laser beam S_{L} gets faster compared to the wafer 40 scanning speed of the laser beam when the stage 30 is standing without moving.

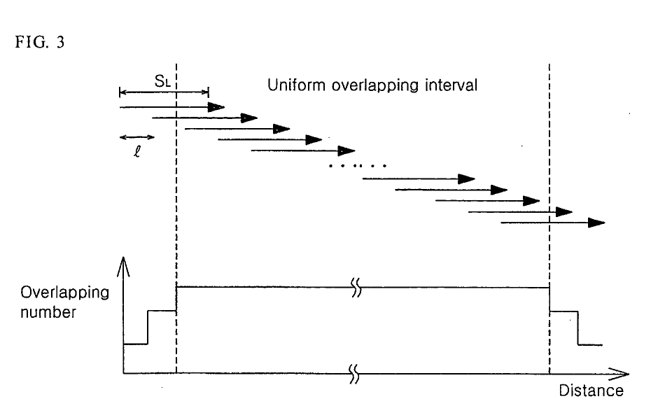

Such overlaps with the scanning length S_{L}, as illustrated in FIG. 3, progress along the direction reverse to the transfer direction of the stage 30 where the wafer 40 is settled. As a result, the wafer 40 on the stage 30 is scanned and cut out by the laser beam along the direction reverse to the transfer direction of the stage 30. During this, the scanning lengths S_{L} continuously overlap from each other in a uniform range, in which the number of overlapping times may be adjustable by controlling the transfer speed of the stage 30.

Provided that a migration distance by the scanning length S_{L} is l along the transfer of the stage 30, an overlapping degree N of the scanning length may be represented in S_{L}/l.

The migration distance l denotes a dimension by which the stage 30 with velocity v moves for a time until one of the reflection planes 12 completes to rotate, being summarized in the following Equation 4. The overlapping degree N is represented in Equation 5.

$$\begin{matrix}l = \frac{v}{\frac{n}{T}} = \frac{v T}{n} = \frac{2 π v}{n ω} & [ Equation 4 ] \\ Overlapping degree ( N ) = \frac{{S}_{L}}{l} = \frac{4 π f}{v T} = \frac{2 ω f}{v} & [ Equation 5 ]\end{matrix}$$

By summarizing the aforementioned description, the angular velocity ω of the polygon mirror 10 with the overlapping degree N while the wafer 40 is cutting out in the velocity v results in Equation 6 as follows.

$$ω = \frac{N v}{2 f} \qquad [ Equation 6 ]$$

As represented in Equation 6, the angular velocity is obtained by dividing a product of the overlapping degree N of the laser beam and the cutout velocity v with a double value of the focal length ƒ of the lens 20, where the cutout velocity v corresponds to the transfer speed of the stage 30 settling the wafer 40 thereon.

While this embodiment uses a polygon mirror shaped with eight reflection planes (i.e., n=8) in eight corners, other polygonal patterns may be available in modification under the scope of the present invention.

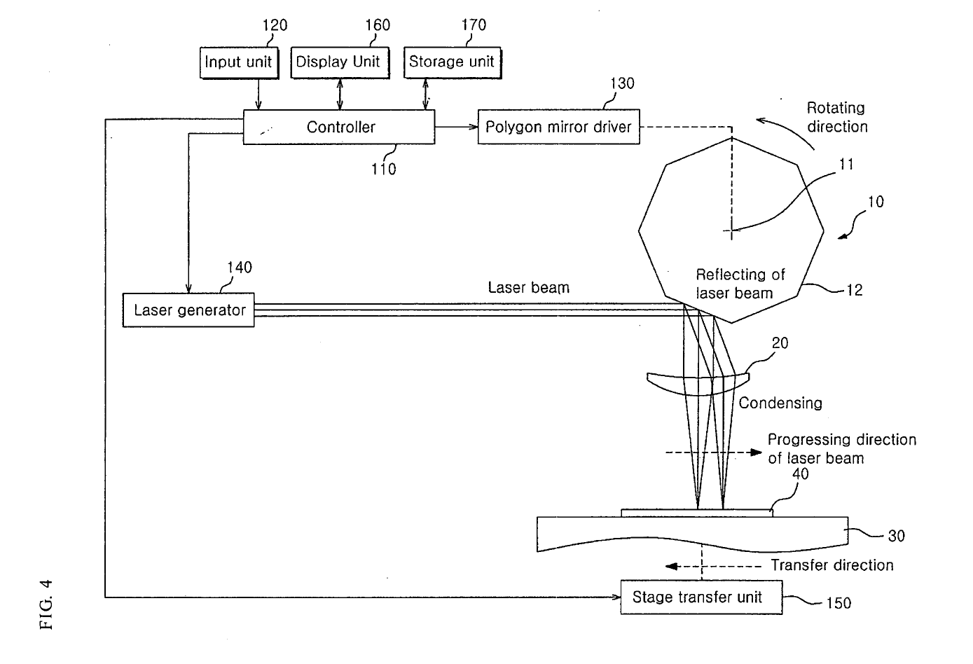

FIG. 4 illustrates an exemplary embodiment of the laser processing apparatus with the polygon mirror in accordance with the present invention.

Referring to FIG. 4, the laser processing apparatus with the polygon mirror according to the present invention is comprised of a controller 110 for conducting an overall operation, an input unit 120 for entering control parameters and control commands, a polygon mirror driver 130 for actuating the polygon mirror 10, a laser generator 140 for emitting laser beams, a stage transfer unit 150 for transferring the stage 30, on which the wafer 40 is settled, in a predetermined direction, a display unit 160 for informing the external users of current operating states, and a storage unit 170 for storing data relevant thereto.

The polygon mirror driver 130 includes a plurality of the reflection plane 12, being configured to make the polygon mirror 10, which has multiple planes, rotate in a predetermined velocity at the axis 11. The polygon mirror 10 uniformly rotates at the axis 11 in the predetermined velocity by means of a motor (not shown) under control of the controller 110.

The laser generator 140 is configured to emit the laser beams to process the wafer 40 as an object settled on the stage 30, generating ultraviolet-ray laser beams under control of the controller 110 in this embodiment.

The stage transfer unit 150 is configured to transfer the stage 30, on which the wafer 40 as an object to be treated is settled, in a predetermined velocity.

In the structure of the laser processing apparatus, laser beams emitted from the laser generator 140 are incident on the polygon mirror 10 under control of the controller 110. The laser beams applied to the polygon mirror 10 are reflected toward the lens 20 from the reflection planes 12, which are rotating by the polygon mirror driver 130, within the range of the scanning angle θ. The laser beams reflected from the reflection planes 12 are condensed on the lens 20, and the condensed laser beam is irradiated on the wafer 40 in perpendicular.

The laser beam being irradiated on the wafer 40 while one of the reflection planes 12 of the polygon mirror 10 is rotating migrates by the scanning length S_{L} along the direction reverse to the transfer direction of the stage 30.

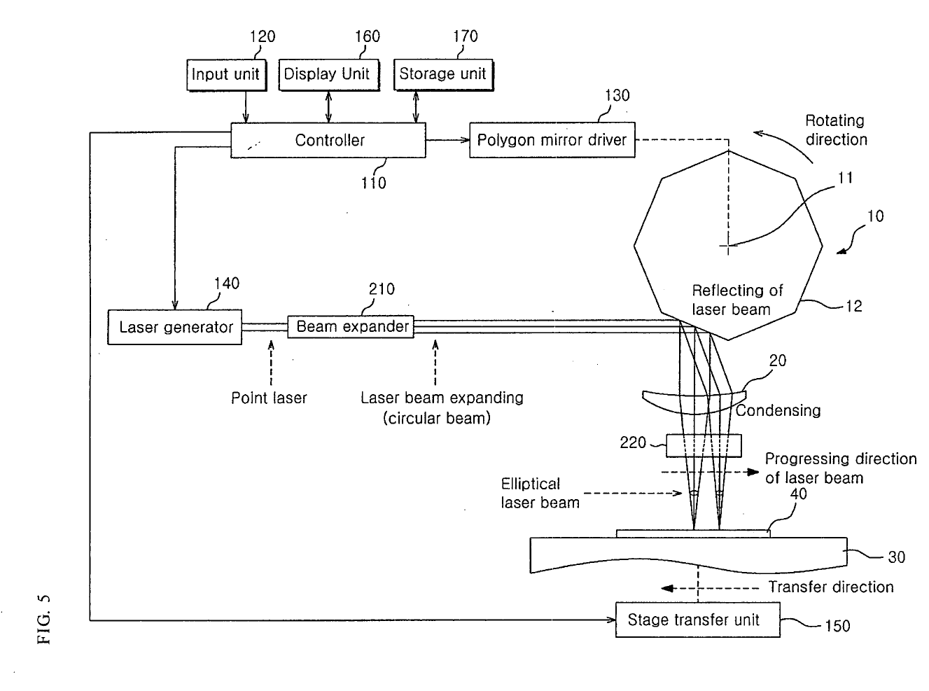

FIG. 5 illustrates another embodiment of the laser processing apparatus with the polygon mirror in accordance with the present invention.

Referring to FIG. 5, the laser processing apparatus with the polygon mirror, in accordance with another embodiment of the present invention, is basically comprised of a controller 110 for conducting an overall operation, an input unit 120 for entering control parameters and control commands, a polygon mirror driver 130 for actuating the polygon mirror 10, a laser generator 140 for emitting laser beams, a stage transfer unit 150 for transferring the stage 30, on which the wafer 40 is settled, in a predetermined direction, a display unit 160 for informing the external users of current operating states, and a storage unit 170 for storing data relevant thereto.

These structures of FIG. 5 are as same as those of FIG. 4. But, the laser processing apparatus with the polygon mirror in FIG. 5 is further comprised of a beam expander 210 for enlarging diameters of pointing laser beams emitted from the laser generator 140 and then applying the enlarged laser beams to the polygon mirror 10, and a beam transformer 220 for converting the laser beam, which is condensed on the lens 20 after being reflected from the polygon mirror 10, into an elliptical pattern. At this time the beam transformer 220 may be easily implemented by employing a cylindrical lens.

The enlarged laser beams incident on the polygon mirror 10 are reflected toward the lens 20 on the reflection planes 12 of the polygon mirror 10 within the range of the scanning angle θ. The laser beam reflected from the reflection planes 12 is condensed on the lens 20, converted into an elliptical pattern by the beam transformer 220 in sectional view, and then irradiated on the wafer 40 in perpendicular.

As the irradiated laser beam has elliptical sectional pattern, a long diameter of the elliptical section corresponds to a direction of cutout processing while a short diameter of the elliptical section corresponds to a width of cutout processing.

When one of the reflection planes 12 is rotating on the axis 11, the laser beam irradiated on the wafer 40 is shifted as the scanning length S_{L} along the direction reverse to the transfer direction of the stage 30.

Hereinafter, it will be described in detail about a procedure of processing an object (i.e., the wafer 40) by means of the laser processing apparatus with the polygon mirror shown in FIG. 5.

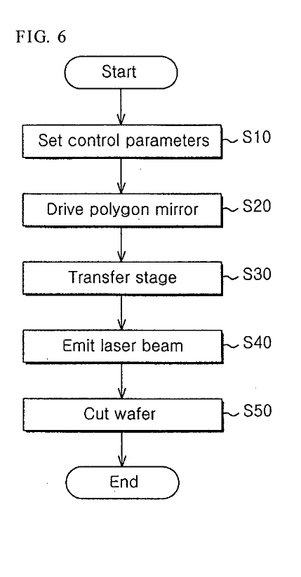

FIG. 6 is a flow chart explaining a procedure of processing an object, in accordance with the present invention.

Referring to FIG. 6, in order to process the wafer, i.e., to cut the wafer 40 out, first control parameters for a rotation velocity of the polygon mirror 10 and a transfer velocity of the stage 30 in the input unit 120 are established, in accordance with a type of the wafer 40 to be processed (step S10). Such setting operations may be simply carried out by retrieving information menus from the storage unit 170 after registering the information, that has been preliminarily designed for wafer types and processing options (e.g., cutting, grooving, and so on), in the storage unit 170.

After completing the establishment for the control parameters, the controller 110 enables the polygon mirror driver 130 to rotate the polygon mirror 10 in a rotation velocity that has been predetermined at the step S10 (step S20), and also enables the stage transfer unit 150 to transfer the stage 30 in a predetermined velocity (step S30). At this point the controller 110 makes the laser generator 140 emit the laser beam (step S40).

Then, the laser beam emitted from the laser generator 140 is incident on the polygon mirror 10 with being enlarged in its sectional diameter after passing through the beam expander 210. The laser beam incident on the polygon mirror 10 is reflected from the reflection plane 12 of the polygon mirror 10 rotating at the axis 11, toward the lens 20 within the range of the scanning angle θ.

The lens 20 condenses the laser beam reflected from the polygon mirror 10, and the condensed laser beam on the lens 20 is irradiated on the wafer 40 in perpendicular after being converted into an elliptical pattern in sectional view by the beam transformer 220. The laser beam finally applied to the wafer 40 has a elliptical sectional pattern in which the long diameter accords to the cutout direction of the wafer 40, i.e., a progressing direction of processing, which extends an irradiation range of the laser beam over the wafer 40 a time, while the short diameter corresponds to a cutout thickness, i.e., a cutout width of processing.

During the procedure, as the polygon mirror 10 rotates with a constant speed, a plurality of the laser beam irradiated on the wafer 40 are overlapped in predetermined times by a plurality of the scanning length S_{L} over the wafer 40.

In addition, as the stage 30 settling the wafer 40 thereon is transferred in the direction reverse to the rotation direction of the polygon mirror 10, a relative speed of irradiation with the scanning length by the laser beam on the wafer 40 becomes faster which makes the wafer cutout process efficient (step S50).

On the other hand, the laser beam emitted from the laser generator 140 is directly irradiated on the wafer 40 when it skips the steps of the beam expander 210 and the beam transformer 220.

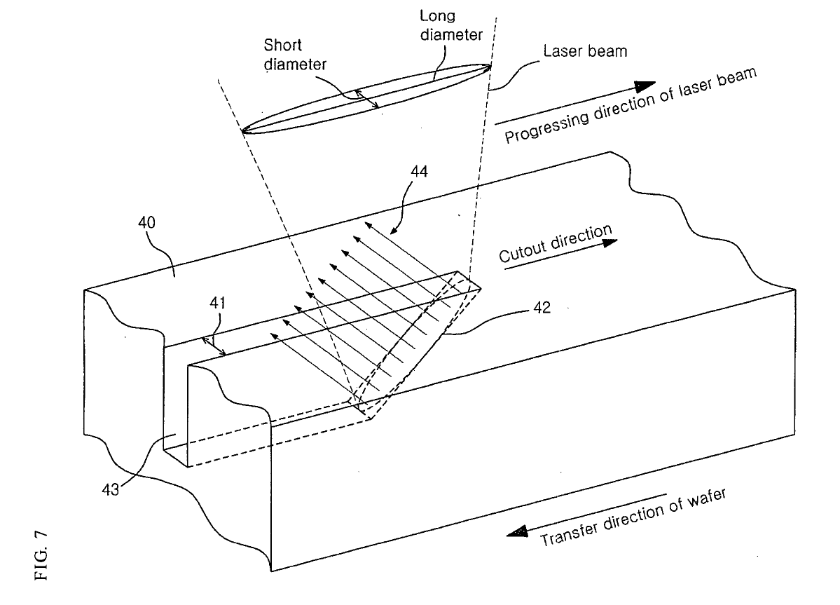

FIG. 7 illustrates a configuration of processing the wafer 40 by the laser processing apparatus with the polygon mirror in accordance with the present invention.

As aforementioned, the laser beam enlarged with its sectional diameter after passing through the beam expander 210 is incident on the polygon mirror 10. The laser beam incident on the polygon mirror 10 is reflected within the range of the scanning angle θ toward the lens 20 on the reflection plane 12 of the polygon mirror 10 that is rotating. The lens 20 condenses the laser beam. The laser beam condensed on the lens 20 is shaped into a sectional elliptical pattern by the beam transformer 220 and then irradiated on the wafer 40.

During this, as the laser beam irradiated on the wafer 40 has the sectional elliptical pattern, the long diameter of the ellipse is associated with a progressing direction on the wafer 40 by the laser beam while the short diameter of the ellipse is associated with a cutout width on the wafer 40 by the laser beam.

As illustrated in FIG. 7, the elliptical laser beam irradiated on the wafer 40 is progressing along the direction of its long diameter, accompanying with the cutout width by its short diameter. In other words, the cutout width 41 of the wafer 40 is adjustable by controlling the short diameter of the elliptical section of the laser beam, which is established by the beam transformer 220.

During the irradiation on the wafer 40 by the laser beam, evaporation may be occurred at places on which the laser beam is irradiated. However, the progressing direction of the laser beam is reverse to the transfer direction of the wafer 40, as aforementioned, so that the relative scanning speed of the laser beam becomes faster and the long diameter of the laser beam is arranged to the processing direction (i.e., the cutout direction). As a result, a cutout section 42 has a slope throughout the cutout process, by which vapors escaping from the wafer material due to the irradiation of the laser beam are easily discharged without depositing on the cutout plane 42 during the process.

Moreover, since the rapid overlapping with the laser beam along the processing direction makes the cutout portion of the wafer 40 be swiftly evaporated, the wafer processing is carried out easily without such as a recasting effect for which vapors from the wafer material are deposited on the cutout wall 43 of the wafer 40.

Although the aforementioned, embodiments is exemplarily describes as being applicable to processing a semiconductor wafer, the present invention is also available to processing other substrates or boards such as plastics, metals, and so on.

As described above, the laser processing apparatus with the polygon mirror in accordance with the present invention needs not any change of additional devices because a laser beam is enough to perform the cutout process, which enables the process to be rapidly carried out in easy and efficiency. Furthermore, since the present invention provides an efficient technique to able to control the cutout width by adjusting the short diameter of the elliptical laser beam and to prevent a recasting effect that causes vapors escaping from an object to be cut out, it is advantageous to processing a wafer in highly precise operations, as well as normal objects.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

1. A laser processing apparatus with a polygon mirror for processing an object by a laser beam, comprising:
a laser generator for emitting the laser beam;
a polygon mirror constructed of a plurality of reflection planes that reflect the laser beam, which is emitted from the laser generator, thereon while rotating on an axis; and
a lens for condensing the laser beam reflected on the polygon mirror and irradiating the laser beam on the object.

2. The laser processing apparatus with the polygon mirror according to claim 1, which further comprises:
a polygon mirror driver rotating the polygon mirror in a constant speed to make the reflection planes revolve with a predetermined angular velocity;
a stage on which the object is settled; and
a stage transfer unit for transferring the stage toward a predetermined direction.

3. The laser processing apparatus with the polygon mirror according to claim 2, wherein the stage transfer unit transfers the stage reverse to a rotating direction of the polygon mirror.

4. The laser processing apparatus with the polygon mirror according to claim 1, which further comprises a beam transformer for converting a sectional pattern of the laser beam condensed on the lens into an ellipse.

5. The laser processing apparatus with the polygon mirror according to claim 4, wherein the beam transformer converts the laser beam to be shaped with the sectional pattern as the ellipse whose long diameter is arranged along a processing direction and then irradiates the converted laser beam on the object.

6. The laser processing apparatus with the polygon mirror according to claim 5, wherein a short diameter of the elliptical section of the laser beam is associated with a processing width by the laser beam, the width being adjustable by controlling the short diameter.

7. A laser processing apparatus with a polygon mirror for processing a wafer, comprising:
a laser generator for emitting a laser beam;
a polygon mirror constructed of a plurality of reflection planes that reflect the laser beam, which is emitted from the laser generator, thereon while rotating on an axis; and
a lens for condensing the laser beam reflected on the polygon mirror and irradiating the laser beam on the wafer that is settled on a stage.

8. The laser processing apparatus according to claim 7, which further comprises:
a polygon mirror driver for rotating the polygon mirror in a constant speed to make the reflection planes revolve with a predetermined angular velocity; and
a stage transfer unit for transferring the stage along a predetermined direction.

9. The laser processing apparatus with the polygon mirror according to claim 8, wherein the stage transfer unit transfers the stage reverse to a rotating direction of the polygon mirror.

10. The laser processing apparatus with the polygon mirror according to claim 7, which further comprises a beam transformer for converting a sectional pattern of the laser beam condensed on the lens into an ellipse.

11. The laser processing apparatus with the polygon mirror according to claim 10, wherein the beam transformer converts the laser beam to be shaped with the sectional pattern as the ellipse whose long diameter is arranged along a processing direction and then irradiates the converted laser beam on the wafer.

12. The laser processing apparatus with the polygon mirror according to claim 11, wherein a short diameter of the elliptical section of the laser beam is associated with a processing width by the laser beam, the width being adjustable by controlling the short diameter.

13. The laser processing apparatus with the polygon mirror according to claim 10, which further comprises a beam expander for enlarging a sectional diameter of the laser beam emitted from the laser generator, the enlarged laser beam being condensed on the lens after reflected on the polygon mirror and being incident on the beam transformer.

14. The laser processing apparatus with the polygon mirror according to claim 7, wherein the lens condenses the laser beam thereon and then irradiates the laser beam on the wafer in perpendicular.

15. The laser processing apparatus with the polygon mirror according to claim 7, wherein a scanning length of the laser beam applied to the wafer from one of the reflection planes in accordance with the rotation of the polygon mirror is adjustable by product of a focal distance of the lens and a scanning angle of the laser beam reflected from the reflection plane of the polygon mirror.

16. The laser processing apparatus with the polygon mirror according to claim 15, wherein the scanning angle of the laser beam is a reflection angle formed by the beginning and rear parts of the reflection plane.

17. The laser processing apparatus with the polygon mirror according to claim 7, wherein the laser beam reflected from the reflection plane in accordance with the rotation of the polygon mirror is irradiated on the wafer being overlapped in a predetermined number and the predetermined number of overlapping is controllable by adjusting an angular velocity of the polygon mirror while a transfer velocity of the stage retains constant.

18. The laser processing apparatus with the polygon mirror according to claim 7, wherein the laser beam reflected from the reflection plane in accordance with the rotation of the polygon mirror is irradiated on the wafer being overlapped in a predetermined number and the predetermined number of overlapping is controllable by adjusting a transfer velocity of the stage while an angular velocity of the polygon mirror retains constant.
